(19) United States
(12) Patent Application Publication
(10) Pub. No.: US 2002/0129524 A1
(43) Pub. Date: Sep. 19, 2002

(54) Interchangeable holiday theme address sign

(76) Inventor: Daniel Jay Haines, Levittown, PA (US)

Correspondence Address: Daniel J. Haines, 59 Dawn Road, Levittown, PA, 19056, US

(21) Appl. No.: 10/087,365

(22) Filed: Mar. 4, 2002

Related U.S. Application Data
(60) Provisional application No. 60/276,077, filed on Mar. 16, 2001.

(51) Int. Cl. G09F 7/02

(52) U.S. Cl. 40/611; 40/617

(57) ABSTRACT

A system for displaying an Interchangeable Holiday Theme Address Sign. The system includes a waterproof display enclosure capable of holding a variety of holiday, sports or personal message displays/logos with or without a personal street address. The waterproof enclosure has an opening for changing the holiday or personal message display. The displays can be easily changed simply by opening the enclosure and replacing it with another display.

Sign to be fabricated in such a way that the Holiday Theme address inserts can be easily changed to display different themes/messages.

Sign to be fabricated to allow the storage of all Holiday Theme address inserts so as to be available for easy changing.

Sign to be designed to be weatherproof and to hang below a horizontal mailbox post, from a porch post or house wall or any other application as required.

Sign to be supplied with a personal message, personal address, personal address with a choice of predetermined picture (clipart) or personal address with a predetermined assortment of Holiday Theme inserts.

Theme inserts can be printed two on one sheet of paper and cut in half.

Personal address can be printed on pre-printed assortment of Holiday Theme inserts.

Sign to be fabricated to allow viewing from both sides.

Sign can be furnished with reflective tape for better viewing at night.

### BRIEF DESCRIPTION OF THE DRAWINGS

FIG. 1 is a drawing showing frame details for holding an address insert.

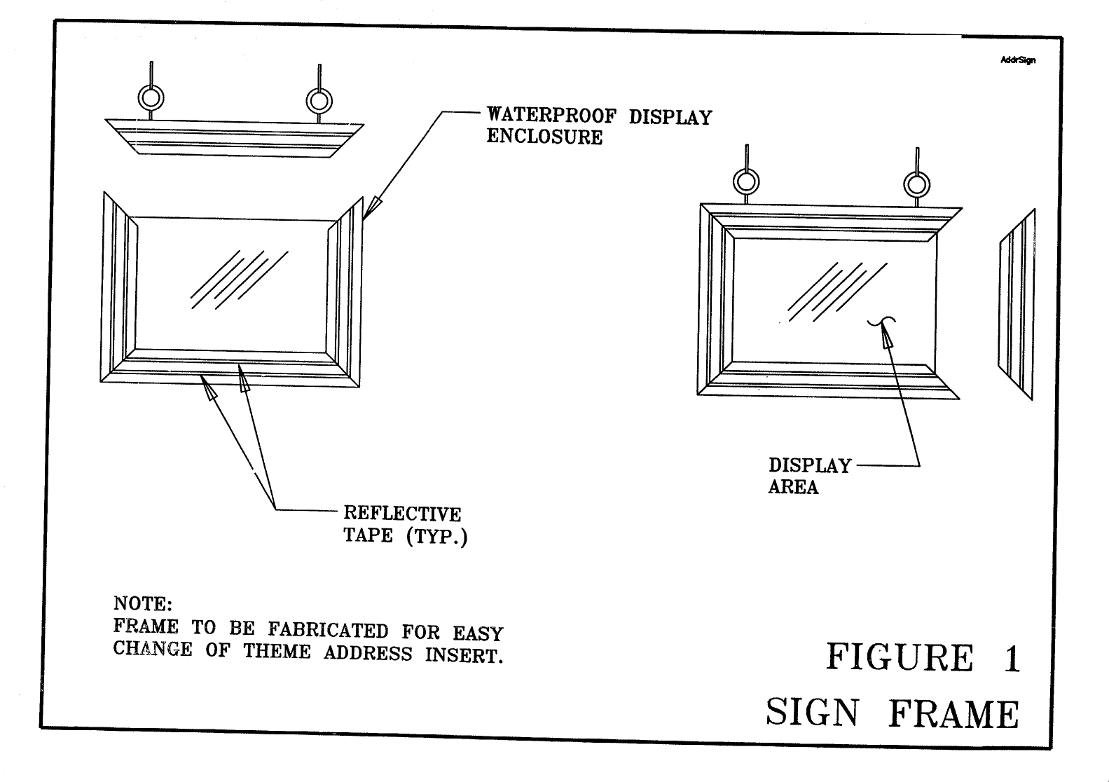

FIG. 2 is a drawing showing typical sign mountings.

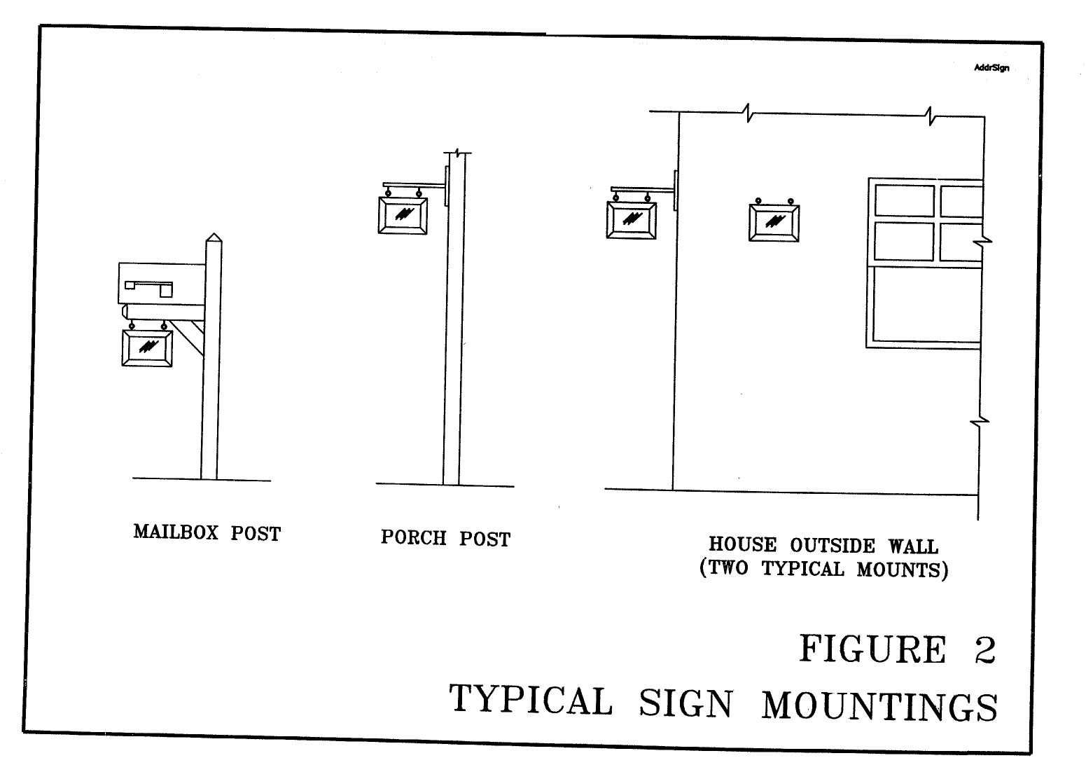

FIG. 3 is an example of product inserts.

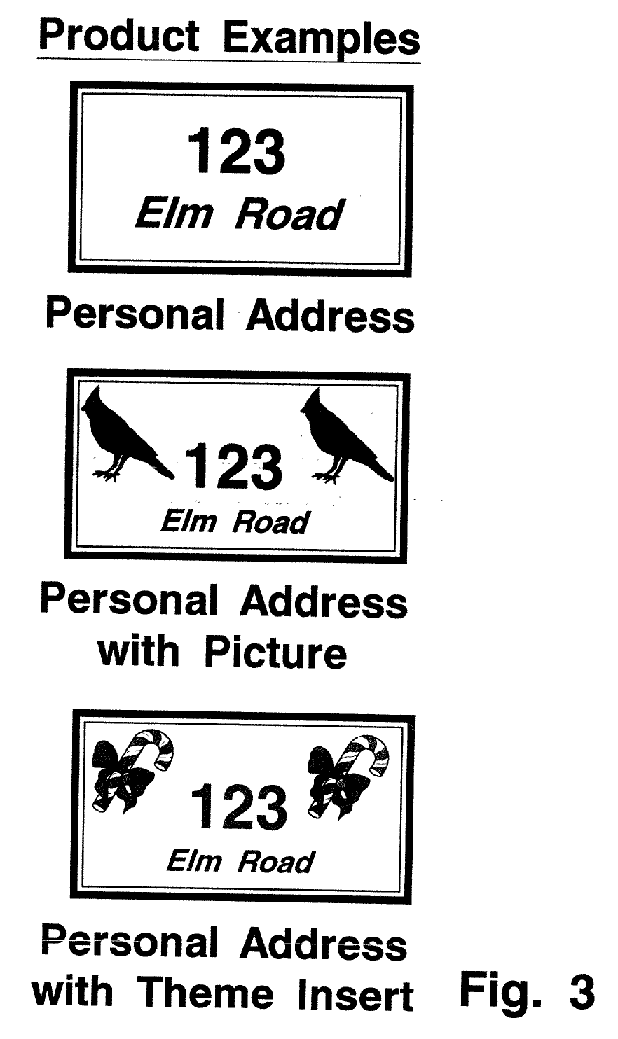

FIG. 4 is a detail showing two (2) inserts printed on a single 8-½″×11″ sheet of paper.

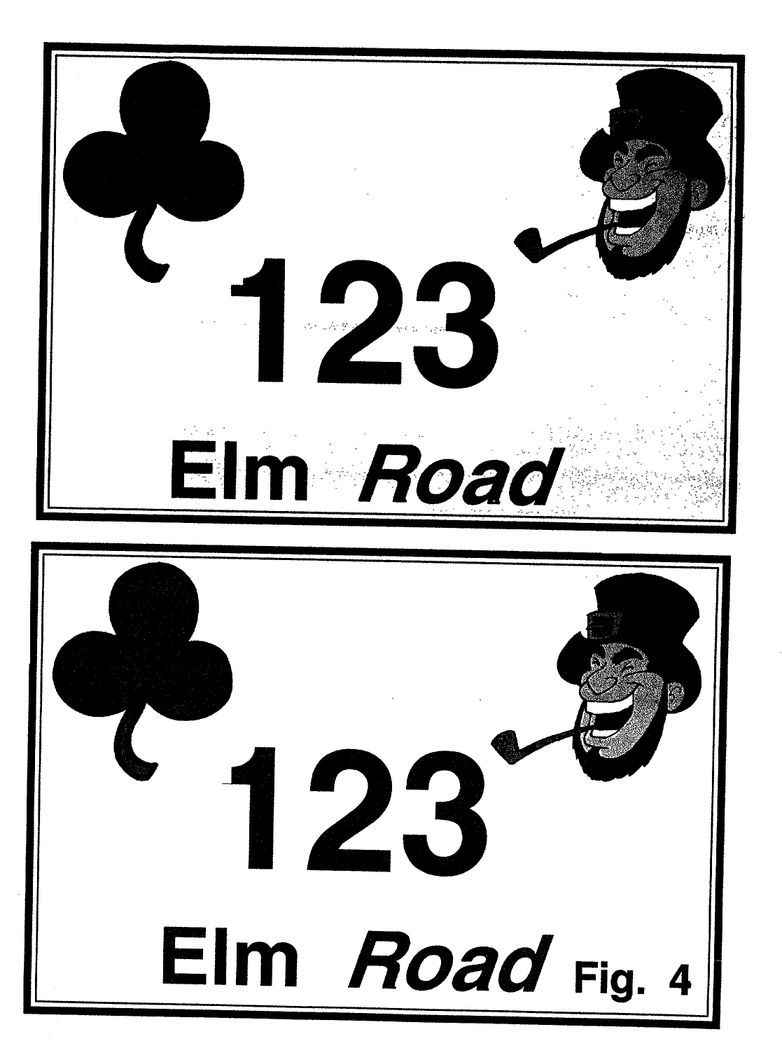

FIG. 5 is an example of holiday theme inserts.

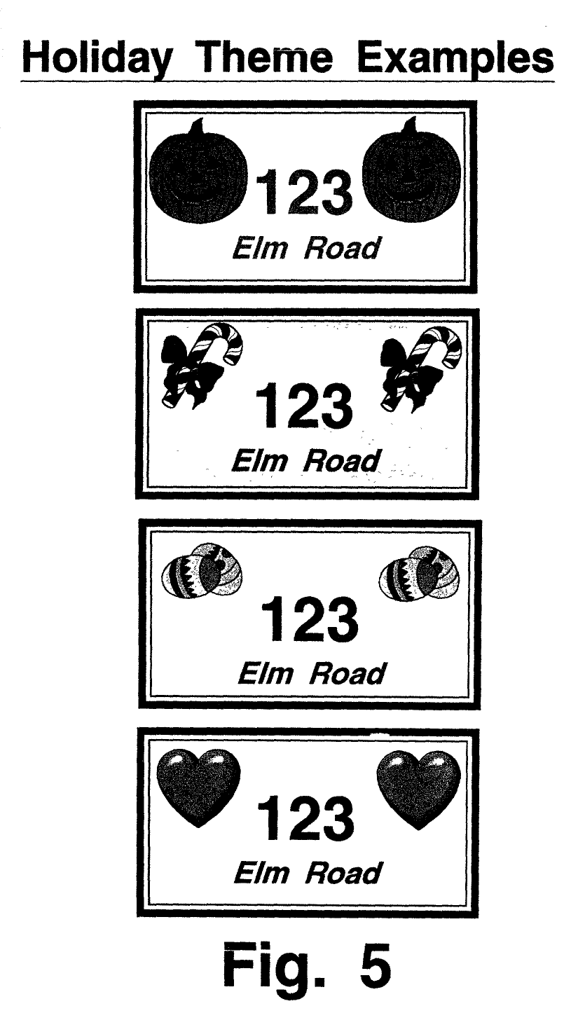

FIG. 6 is an example of sports/college theme inserts.

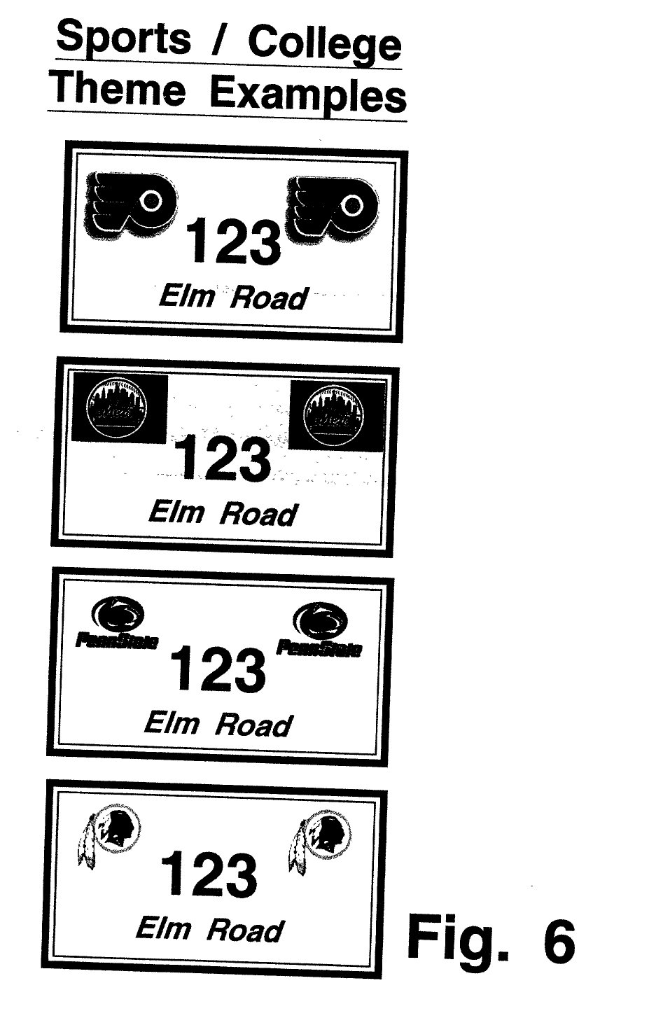

FIG. 7 is a photocopy of a prototype enclosure with a holiday theme insert.

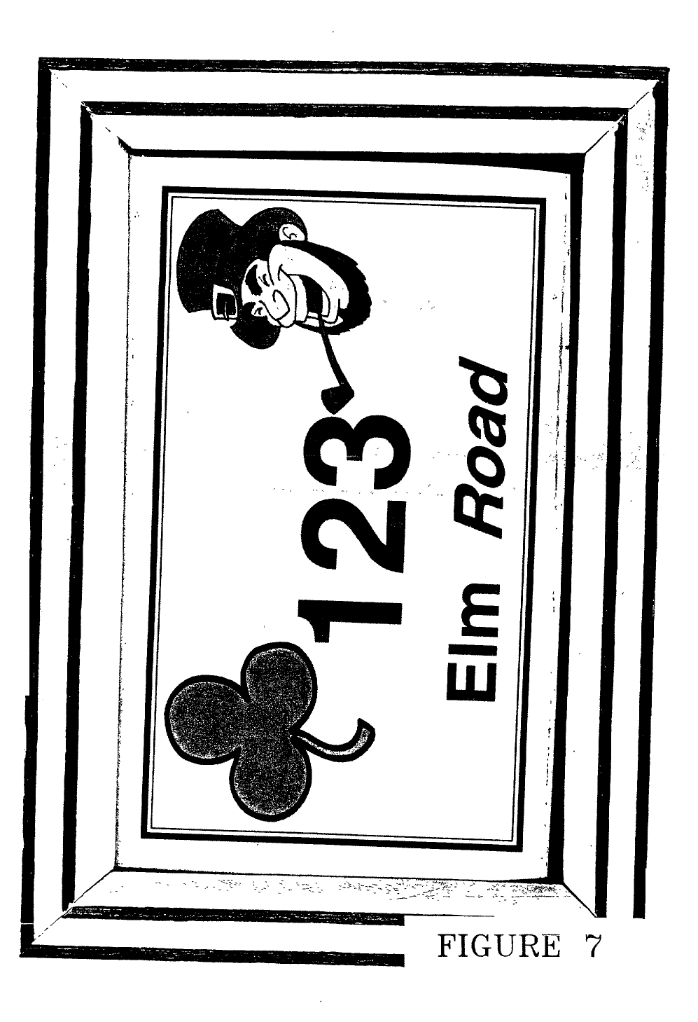

What is claimed is:

1. A system for displaying messages comprising: a plurality of image panels, each panel to display a variety of image designs, said panels to be removably mountable and interchangeable, such that said panels may be removably mounted to any of said designs, thereby displaying a desired design or message; and each of said image designs to display a holiday, sports or personal message.

2. The system of claim 1, wherein the display images may or may not show a personal street address.

3. The system of claim 1, wherein the display enclosure is capable of storing a variety of display panels.

4. The system of claim 1, wherein the display enclosure is capable of displaying image panels on both sides.

5. The system of claim 1, wherein the mountable enclosure may or may not be of a reflective nature.
